(19) United States
(12) Patent Application Publication
(10) Pub. No.: US 2016/0135647 A1
(43) Pub. Date: May 19, 2016

(54) DEVICE FOR THE COMMINUTION OF FOODSTUFFS

(71) Applicant: Genius GmbH, Limburg (DE)

(72) Inventor: Cedomir Repac, Brechen (DE)

(21) Appl. No.: 14/898,760

(22) PCT Filed: Apr. 22, 2015
(86) PCT No.: PCT/EP2015/058656

§ 371 Date: Dec. 16, 2015

(30) Foreign Application Priority Data
May 5, 2014 (DE) 20 2014 102 077.2

(51) Int. Cl. A47J 43/044; B26D 5/10

(52) U.S. Cl. CPC A47J 43/044; B26D 5/10; A47J 2043/04454

(57) ABSTRACT

The invention relates to a device (1) for the comminution of foodstuffs, which device has a drive device (12) for driving at least one rotary cutter (13) in rotation and has a container (7). The device is characterized in that the drive device (12) is fixable or fixed, in particular articulatedly, to a base part (2) and in that a holding device (18) is provided which, for the rotatable mounting of the at least one rotary cutter, is insertable or inserted into the base part (2).

### CROSS-REFERENCE TO RELATED APPLICATIONS

The present application is the U.S. national phase of International Application No. PCT/EP2015/058656 filed Apr. 22, 2015, which claims priority of German Application No. 20 2014 102 077.2 filed May 5, 2014, the entirety of which is incorporated herein by reference.

### FIELD OF THE INVENTION

The invention relates to a device for the comminution of foodstuffs, which device has a drive device for driving at least one rotary cutter in rotation and has a container.

### BACKGROUND OF THE INVENTION

For example, EP 1 385 409 B1 has disclosed a kitchen appliance having a rotary cutter which is driven in rotation.

Furthermore, other appliances are also known which have a different functional mechanism.

For example, DE 102 42 651 A1 has described a cutting appliance for foodstuffs or similar items for cutting, having a cutting part on which there are fitted multiple substantially parallel cutters which have cutting edges, said cutting edges forming a cutting surface for the items for cutting in order to cut said items into strips or slices or similar. An actuation part in the form of a plunger has a base surface which can be moved toward and away from the cutting surface, with the items for cutting situated in between. The base surface has groove-like or slot-like receptacles which substantially correspond to the cutters and which have interposed webs. The base surface acts on the items for cutting and moves these toward the cutting surface and through between the cutters. It is provided that the cutting part and the plunger are arranged in the region of the free end of a respective arm of tongs, wherein the arms of the tongs are pivotably connected in the region of the other, free end by means of a pivot bearing, and wherein the arms of the tongs are preloaded into an open position by means of a spring.

A similar appliance with a special cutting blade arrangement is known from DE 20 2007 018 922 U1.

The appliances mentioned above are appliances which are held in one hand, similarly to a pair of tongs, and in the case of which the comminution process is performed by closing the hand in which the comminution device is held, with two arms of the tongs being pushed together as a result.

As described below, appliances also exist which are of completely different design, and which are not held in the hand but which are placed on a worktop. These appliances normally have a container for the comminuted items. The only common aspect that these appliances share with the appliances mentioned above is the comminution principle, specifically the fact that the items for comminution are pushed through a cutting device.

For example, DE 10 2009 023 167 A1 discloses a device for cutting foodstuffs, such as fruit and vegetables, having a cutting part which has multiple cutting edges, and having an actuation part, said cutting part and actuation part being mounted so as to be pivotable relative to one another. To cut the items for cutting, the actuation part is pushed towards the cutting part, wherein the actuation part has a plunger which pushes the items for cutting through the cutting part, wherein the cutting edges protrude into corresponding depressions of the plunger. The cutting part has a cutting frame in which cutting blades are held. The device furthermore has a cover part for mounting on a receiving container for the cut items for cutting, wherein the cover part has an opening which forms a passage for the cut items for cutting.

Other devices for placing on a worktop are known for example from DE 20 2011 050 041 U1 and from DE 21 2005 000 048 U1.

U.S. Pat. No. 1,263,151 has disclosed a device in which, depending on cutting requirements, one cutting insert out of a multiplicity of different stored cutting inserts for the comminution of food items is installed.

Various food slicers are known from GB 2 032 260 A, EP 1 918 078 A2 and DE 91 10 587 U1. Said food slicers firstly have a horizontal cutter, and may secondly also have vertical cutters on their cutting side. The horizontal cutter serves for slicing or cutting the food items into slices, and the additional vertical cutters serve for cutting the food items into strips.

The preparation of meals that are common nowadays, such as for example salads, requires widely varied options for the comminution of different food items. Firstly, it is for example necessary for one food item, for example a cucumber, to be sliced for the preparation of a salad. Secondly, for the preparation of the same salad, it is additionally necessary for a further food item, for example cheese or meat items, to be cut by being pushed through a cutting part. For the preparation of such meals, different implements are required, which each operate specifically on the basis of exclusively one predefined comminution principle and which are used entirely separately from one another. After the comminution processes, the user must bring together the food items that have been comminuted using the different implements, in order that said food items can be mixed with one another, for example for the preparation of a mixed salad.

### SUMMARY OF THE INVENTION

It is therefore the object of the present invention to specify a device of the type mentioned in the introduction which permits a quick supply of the items for comminution and which can be quickly moved into a comminution position after a filling process.

The object is achieved by means of a device of the type mentioned in the introduction, which device is characterized in that the drive device is fixable or fixed, in particular articulatedly, to a base part and in that a holding device is provided which, for the rotatable mounting of the at least one rotary cutter, is insertable or inserted into the base part.

The invention has the advantage that the free end of the rotary cutter, or the free ends of the rotary cutters, are held securely in position, such that the drive device can, for example after a process of supplying food items for comminution, can be quickly and reliably operatively coupled to the rotary cutter, or to the rotary cutters, again without the user having to expend additional effort for alignment purposes.

In a very particular advantageous embodiment, the device has two rotary cutters for being rotatably inserted into the container, wherein the drive device is designed to drive the two rotary cutters. In this embodiment, the holding device preferably has two bearing receptacles for the rotatable mounting of the two rotary cutters. In particular, it may advantageously be provided that the bearing receptacles are formed by two mutually parallel apertures in the holding device.

To permit a quick supply of food items for comminution, the holding device may have a passage for the food items for comminution and/or comminuted food items.

In a particularly advantageous embodiment, the holding device is designed to be transparent. Such an embodiment has the particular advantage that the user can more easily check how full the container is.

In a very particular advantageous embodiment, the drive device is articulatedly fixable or fixed to the base part. In particular, it may advantageously be provided that the drive device, which is articulatedly fixed to the base part, can be selectively pivoted into an open position or a closed position. Such an embodiment has the particular advantage that the drive device can, for example for a supply of food items for comminution, be briefly pivoted into an open position without the drive device having to be completely detached from the base part. It is achieved in this way that, after a supply process, the drive device can quickly, and without additional expenditure of effort for alignment purposes, be operatively coupled again to the rotary cutters, the free ends of which are held by the holding device.

In a very particularly advantageous embodiment, the base part has a receptacle for a cutting part and a cutting part. In this embodiment, an actuation part is articulatedly fixable to the base part in exchange for the drive device such that the actuation part can be pivoted toward the cutting part, inserted in the receptacle, in order to push through food items for comminution.

Such an embodiment has the very special advantage that the user can choose between two different comminution options which are available to him or her. For example, using the same appliance, after a comminution process by way of a pushing action through a cutting part, a comminution process can be performed by way of the rotary cutters. Also, for example, after a comminution process by way of the rotary cutters, a comminution process by way of a pushing action through a cutting part can be performed. The user merely has to fix the actuation part to the base part and insert a cutting grate if he or she wishes to perform a comminution process by way of a pushing action through a cutting part. Alternatively, if the user wishes to perform a comminution process using the rotary cutters, he or she can, in particular articulatedly, fix the drive device rather than the actuation part to the base part, and insert the rotary cutters into the chambers.

In an advantageous embodiment, the drive device has at least one hand crank.

In a particularly advantageous embodiment, the drive device has a gearing, in particular a speed-increasing gearing. In this way, it is possible for the one or more rotary cutters to be driven manually, for example by way of a hand crank, at particularly high rotational speed.

In a particular embodiment, the device has at least one driven shaft to which a rotary cutter can be rotationally conjointly coupled. In particular, it may advantageously be provided that the drive device has two driven shafts to which in each case one rotary cutter can be rotationally conjointly coupled.

Owing to the articulated connection of the drive device, the user furthermore has the very special advantage that he or she can, without great effort, in particular even when the base part is fixed to a container opening, pivot the actuation part or the drive device upward in order, for example, to check how full the container is or in order to remove food items that have become stuck.

The articulated connection between the base part and the actuation part and the articulated connection between the base part and the drive device may be realized in different ways. What are particularly advantageous are articulated connections which can be joined together and detached again in a simple manner, in particular without tools and/or by way of a simple plugging-together and pulling-apart action.

In a particular embodiment, the base part, on the one hand, has at least one joint head and the actuation part and/or the drive device, on the other hand, has a corresponding joint receptacle for forming the articulated connection. It may self-evidently also conversely be provided that the actuation part and/or the drive device, on the one hand, has at least one joint head and the base part, on the other hand, has a corresponding joint receptacle for forming the articulated connection.

In a particular embodiment, the articulated connection is designed such that the actuation part or the drive device, at least in a predefined pivoting position, is detachable from the base part, in particular without tools and/or exclusively by virtue of the actuation part and base part being pulled apart. In particular, the articulated connection may also be designed such that the actuation part or the drive device, exclusively in a predefined pivoting position or in a predefined pivoting position range, is detachable from the base part, in particular without tools and/or exclusively by virtue of the actuation part and base part being pulled apart.

The predefined pivoting position may for example lie at an angle in the range from 80° to 100°, in particular at an angle of 90°, between the plane of the base part and the plane of the actuation part. The two planes are characterized in that they have a common straight line of intersection which is parallel to the axis of rotation of the actuation part and the base part. In particular, it may also be provided that the predefined pivoting position range has an angle range of 70° to 110°, in particular of 80° to 100°, in particular of 85° to 95°, between the plane of the base part and the plane of the actuation part.

In a particular embodiment, to realize detachability of the articulated connection, the joint head receptacle has a radial opening through which the joint head can be removed from or inserted into the joint head receptacle in a radial direction. It may very generally be provided that the joint head receptacle has an opening through which the joint head can be removed from or inserted into the joint head receptacle along a direction that differs from the direction of the pivot axis of the articulated connection.

In particular, in the case of one of the abovementioned devices, it may advantageously be provided that the joint head is of non-circular, in particular rectangular, form in cross section. Specifically, in a particular pivoting position, a joint head of said type can be inserted into the joint head receptacle through the opening of the joint head receptacle, whereas, in a different pivoting position, said joint head cannot exit the joint head receptacle through said opening.

In a very particularly advantageous embodiment, the device has at least one drive device, in particular a spring drive, for assisting or effecting the pivoting movement of the actuation part and/or of the food slicer from a closed position into a loading position and/or from a loading position into a closed position.

A device of said type has in particular the very special advantage that it can be operated using one arm. It may for example be provided that the user uses one hand to place items for comminution onto the cutting part and subsequently uses the other hand to pivot the actuation part toward the cutting part and thus place a spring of a drive device, which is in the form of a spring drive, under stress. By means of the force exerted by the stressed spring, the actuation part can move back from the closed position into the loading position again automatically—that is to say without the user having to hold the base part still with one hand—after the comminution process has been performed. The user can consequently use one hand exclusively for placing further items for comminution onto the cutting part after every comminution process, while using the other hand exclusively for pivoting the actuation part from the loading position into the closed position.

In this way, it is possible for a significantly greater quantity of food items to be processed in the same length of time, because the procedures can be carried out very much more quickly and without the user having to change their grip, which is inconvenient and time-consuming.

In one advantageous embodiment, it is provided that the drive device is selectively activatable or deactivatable and/or that the assistance force of the drive device is adjustable.

A deactivation is preferably realized by virtue of the actuation part being freely pivotable relative to the base part when the drive device is deactivated. It may however also be provided that a deactivation is realized by virtue of pivoting of the actuation part relative to the base part no longer being possible.

Such an embodiment has the advantage that it can be adjusted, in accordance with the type of items for comminution, such that a fast and efficient comminution process is always made possible.

For example, in the case of a device in which the drive device has at least one spring which is placed under stress during the pivoting of the actuation part from the loading position into the closed position and which relaxes so as to assist the pivoting movement of the actuation part from the closed position into the loading position, a deactivation of the drive device may be realized if particularly hard foods are to be comminuted, for which purpose the user requires their full force in any case. This prevents a situation in which the user must additionally impart energy for placing the spring under stress during the pivoting of the actuation part from the loading position into the closed position.

By contrast, for the comminution of foodstuffs which can be pushed through the cutting part by means of the actuation part with little expenditure of force, the drive may be activated; for example in order to assist or automatically effect the pivoting of the actuation part from the closed position into the loading position.

In the case of a device in which the assistance force of the drive device is adjustable, it is advantageously possible, for example in a manner dependent on the cuttability of the foodstuff, for an intermediate setting between full deactivation and full activation to be selected.

In a particular embodiment, the base part has a passage for the food items for comminution and/or the comminuted food items. Alternatively or in addition, it may also be provided that a holding device for the rotatable mounting of at least one rotary blade has a passage for the food items for comminution and/or the comminuted food items.

In a particular embodiment, to convert the device from cutting by way of a pushing-through action to cutting by way of the rotary cutters, it is merely necessary for the cutting part to be removed from the receptacle and for the actuation part to be replaced with the drive device, and for at least one rotary cutter to be inserted for example into a container of the device.

Instead of the cutting part, it is advantageously possible for a holding device to be inserted into the base part for the purposes of rotatably mounting at least one rotary cutter in the base part. In particular, a holding device of said type may have two bearing receptacles for the rotatable mounting of two rotary cutters. For example, it may advantageously be provided that the bearing receptacles are formed by two mutually parallel apertures in the holding device.

In a particularly individually usable embodiment, it is provided that multiple cutting parts can be inserted simultaneously into the receptacle and/or that cutting parts of different size can be inserted into the receptacle.

The device may in particular be designed to be placed on a worktop for a comminution process.

In an advantageous embodiment, the device has a container, It can in particular be advantageously provided that the device has a container with two, in particular interconnected, cylindrical chambers into which in each case one rotary cutter can be inserted, and/or in that the device has a container with two cylindrical chambers which merge into one another and into which in each case one rotatry cutter can be inserted. Such an embodiment has the particular advantage that a co-rotation of the food items for comminution together with the two rotary cutters is prevented, because the food items are held stationary on the walls of the cylindrical chambers, which chambers are adapted to the rotary cutters. In particular, in order to intensify this effect, the inner sides of the chambers may have axially oriented ribs.

Such a device with two, in particular interconnected, cylindrical chambers furthermore has in particular the advantage that, through the use of two rotary cutters which are driven in rotation simultaneously by means of the drive device, it is possible for foodstuffs to be processed more quickly and/or in greater amounts than with a device which has only a single rotary cutter. In the case of the device according to the invention, the special shape of the container very particularly advantageously has the effect of preventing parts of the food items for comminution from being removed from the comminution process as a result of them collecting in regions that the rotary cutters do not reach.

In a particular embodiment, the rotary cutters which are driven by the drive device rotate in the same direction. Such an embodiment has the special advantage that the tendency for the food items to co-rotate with one of the rotary cutters is further reduced.

The device may advantageously be in the form of a cover which can be mounted on a container—preferably so as to completely cover the container opening—and/or can be fixed to a container. The comminuted foodstuff can in this way be safely and reliably collected in the container. In particular, in this way, it is also realized that undesired articles are prevented from passing into the meal in the container. This applies in particular in the case of multiple meals being prepared simultaneously in a kitchen area. Furthermore, removal of the device after use is not necessary in order to attach a separate cover. This applies in particular in the case of short time intervals between periods of use of the device.

In a particular embodiment, the base part is in the form of a container for the comminuted foodstuff. Furthermore, a container of said type may also be in the form of a stand for enabling the food comminution device to be placed on a worktop.

In a particular embodiment, the device has at least one, in particular two, rotary cutters for being rotatably inserted into the container. In particular, it may advantageously be provided that the two rotary cutters are inserted rotatably into the container such that said rotary cutters are rotatable about parallel axes of rotation.

An embodiment is particularly advantageous in which the container has at least two rotary bearings for the rotatable mounting of a rotary cutter, and/or in which the container has two rotary bearings for the rotatable mounting of two, in particular parallel, rotary cutters. In particular, the rotary bearing may be in the form of a pin which is arranged on the inner side of the container base and onto which a rotary cutter can be or is mounted. Alternatively or in addition, it may also be provided that the container has, on the inner side of the container base, two mutually parallel pins as rotary bearings for the rotatable mounting of two rotary cutters, wherein in each case one rotary cutter can be or is mounted onto each pin.

In an advantageous embodiment, the drive device, which is articulatedly fixed to the base part, can be selectively pivoted into an open position or a closed position. Here, it may be provided in particular that the drive device, in the open position, is not coupled to the at least one rotary cutter inserted into the container. Alternatively or in addition, it may also be provided that the drive device, in the closed position, is coupled to the at least one rotary cutter inserted into the container, and/or that the drive device, during the movement from the open position into the closed position, is automatically placed in operative connection with the at least one rotary cutter inserted into the container. In a particularly advantageous embodiment, the drive device, which is articulatedly fixed to the base part, and the at least one rotary cutter inserted rotatably into the container are positioned such that they are automatically placed in operative connection with one another during the movement of the drive device from the open position into the closed position. In particular, such an embodiment allows the user to occasionally interrupt the comminution process in order to inspect the comminuted food items by moving the drive device into the open position. This applies in particular if the holding device for the rotatable mounting of at least one rotary cutter is of transparent form.

In a particular embodiment, the at least one rotary cutter has a rotary shaft on which at least one blade is arranged, in particular so as to run radially outward proceeding from the rotary shaft. Alternatively or in addition, it may be provided that the at least one rotary blade has a rotary shaft on which two blades, which are offset by 180 degrees, are arranged in particular so as to run in each case radially outward proceeding from the rotary shaft.

What is very particularly advantageous is a kitchen appliance which has a container for collecting the comminuted items and a food comminution device according to the invention which is designed as a cover for the container. In this case, it may advantageously be provided in particular that the food comminution device in the form of a cover can be mounted on the container so as to completely cover the container opening. In particular, it may additionally be provided that, for a comminution process, the food comminution device can be fixed temporarily to the container edge, for example by way of a screw connection or by way of a detent connection.

It is advantageously possible for the kitchen appliance to be designed to be placed on a worktop for a comminution process.

It may for example be provided that the container of the kitchen appliance is in the form of a stand for enabling the food comminution device to be placed on a worktop. For example, supporting feet, in particular non-slip supporting feet composed of rubber or some other elastic material, may be arranged on the outer side of the base of the container.

### BRIEF DESCRIPTION OF THE DRAWING VIEWS

The subject matter of the invention is schematically illustrated in the drawing and will be described below on the basis of the figures, wherein identical elements or elements of identical action are normally denoted by the same reference signs. In the drawing:

FIG. 1 shows a cross section, from a side elevation, of an exemplary embodiment of a device according to the invention, having a base part and an actuation part,

FIG. 2 shows a cross section, from a side elevation, of the exemplary embodiment of a device according to the invention, having a base part, wherein the actuation part has been replaced with a drive device for driving rotary cutters in rotation,

FIG. 3 shows a cross section, from a side elevation, of the exemplary embodiment of a device according to the invention, having a base part, wherein the actuation part has been replaced with a drive device for driving rotary cutters in rotation, in the closed position,

FIGS. 4 and 5 illustrate an exemplary embodiment of the joint for the pivotable mounting of the actuation part and of the drive device on the base part,

FIG. 6 shows a possible embodiment of a container of an exemplary embodiment of a device according to the invention in a cross-sectional illustration,

FIG. 7 is a cross-sectional illustration of another exemplary embodiment of a device according to the invention, and

FIG. 8 is a cross-sectional illustration of a further exemplary embodiment of a device according to the invention.

### DETAILED DESCRIPTION OF THE INVENTION

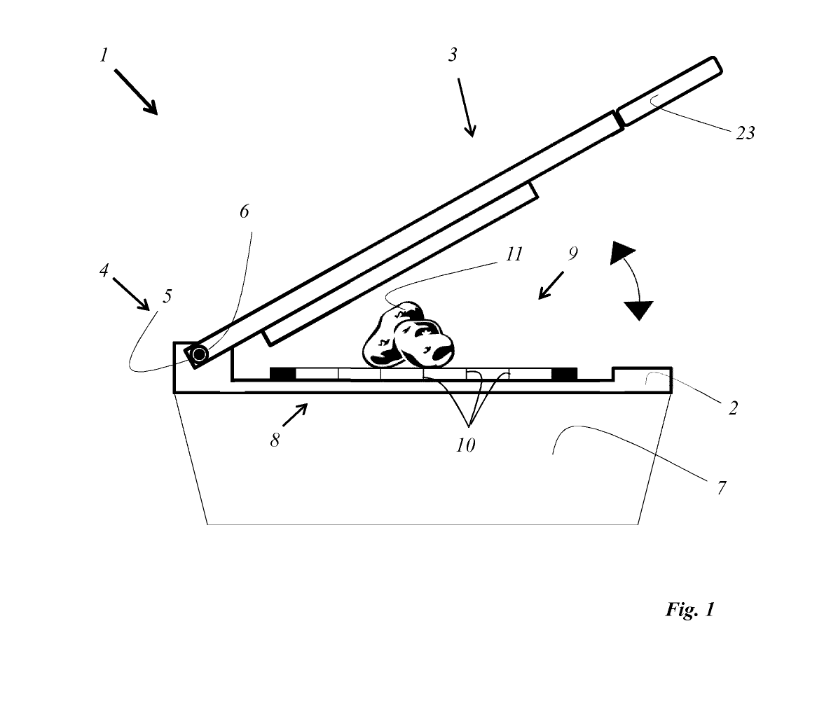

FIG. 1 shows a cross section, from a side elevation, of an exemplary embodiment of a device 1 according to the invention, having a base part 2 and an actuation part 3 which are connected to one another by way of a joint 4. The joint 4 has a joint head 5 and a joint shell 6 which at least partially encloses the joint head 5. A handle 6 is fastened to the actuation part 3. The base part 2 is mounted on a container 7 and has a receptacle 8. In the receptacle 8 there is arranged a cutting part 9, wherein the cutting part 9 has cutting part blades 10. The actuating part 3 has pressing plungers (not illustrated) which are designed and arranged such that they can penetrate into the space between the cutting blades 10. The double arrow illustrates the possible pivoting directions for the actuation part 3 about the pivot axis of the joint 4.

A user can place a food item 11 onto the cutting part 9 and push the latter through the cutting part 9 by pivoting the actuation part 3. As the food item 11 is pushed through the cutting part 9, the food item 11 is cut into pieces by the cutting part blades 9. The comminuted food item 11 falls into the container 7 and is collected there.

The user can also cut different food items 11 in succession by way of the cutting part 9. Alternatively, it is also possible for multiple food items 11 to be placed onto the cutting part 9, and cut into pieces, simultaneously. The user may furthermore exchange the cutting part 9 for a different cutting part, for example in order to realize different cutting forms and/or in order to cut a different food item 11 into pieces. In this case, the cutting process using the different cutting part takes place analogously to that described above.

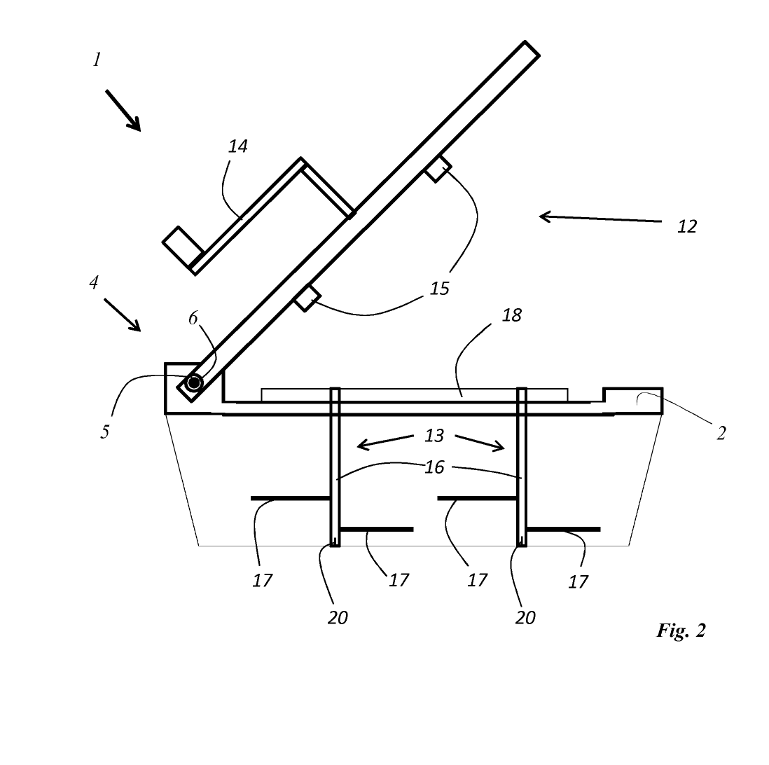

FIG. 2 shows a cross section, from a side elevation, of the exemplary embodiment of a device 1 according to the invention, having a base part 2, wherein the actuation part 3 has been replaced with a drive device 12 for driving rotary cutters 13 in rotation. The drive device 12 has a hand crank 14 to which in each case one of the rotary cutters can be rotationally conjointly coupled. Furthermore, the drive device 12 has two driven shafts 15 to which in each case one of the rotary cutters 13 can be rotationally conjointly coupled. For this purpose, each of the driven shafts 15 has an internal toothing into which the ends, equipped with a corresponding external toothing, of the rotary shafts 16 of the rotary cutters 13 automatically engage when the drive device 12 is pivoted down. During the pivoting of the drive device 12, the rotary shafts 16 of the rotary cutters 13 automatically detach from the driven shafts 15.

On each of the rotary shafts 16 there are arranged three blades 17 which are offset by 120 degrees and which run radially outward proceeding from the rotary shaft. Alternatively, it is for example also possible for two blades 17 which are offset by 180 degrees to be arranged on each of the rotary shafts 16. In particular, the blades may be arranged at different axial heights of the rotary shaft.

Into the base part 2 there can be inserted, instead of the cutting part 9, a holding device 18 which has two bearing receptacles 19 for the rotatable mounting of the rotary shafts 16.

The container 7 has, on the inner side of the container base, two mutually parallel pins 20 as rotary bearings for the rotatable mounting of the rotary shafts 16 of the lower ends of the rotary cutters 13, wherein in each case one rotary cutter 13 can be mounted onto each pin 20.

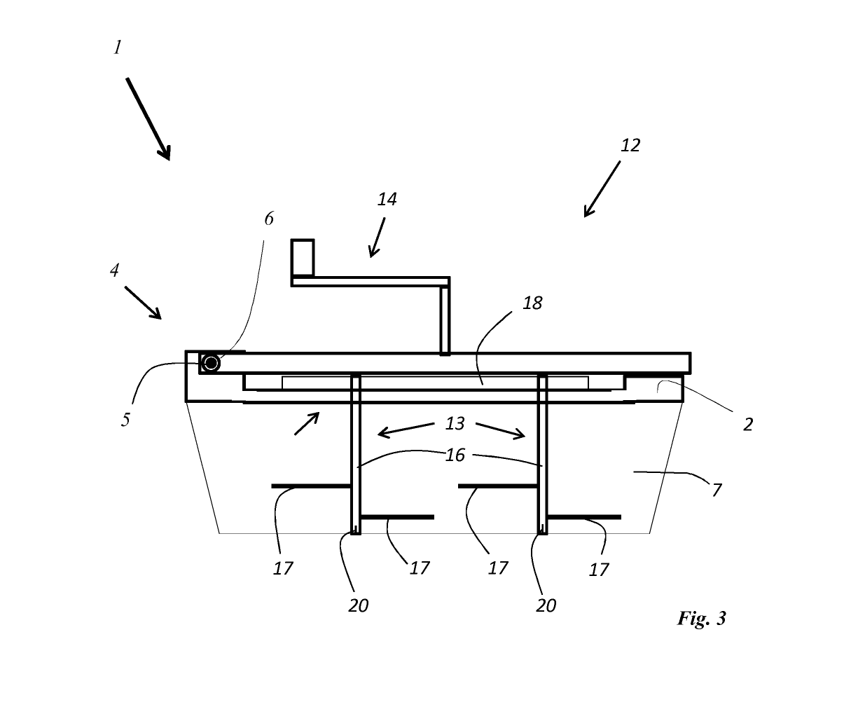

FIG. 3 shows a cross section, from a side elevation, of the exemplary embodiment shown in FIG. 2, with the drive device 12 in the closed position. In this position, the drive device 12 and the rotary blades 13 are operatively connected such that a rotation of the rotary blades 13 can be effected by rotating the crank 14. Here, the drive device 12 may comprise a speed-increasing gearing, such that the rotational speeds of the rotary blades 13 can be significantly higher than that of the crank 14.

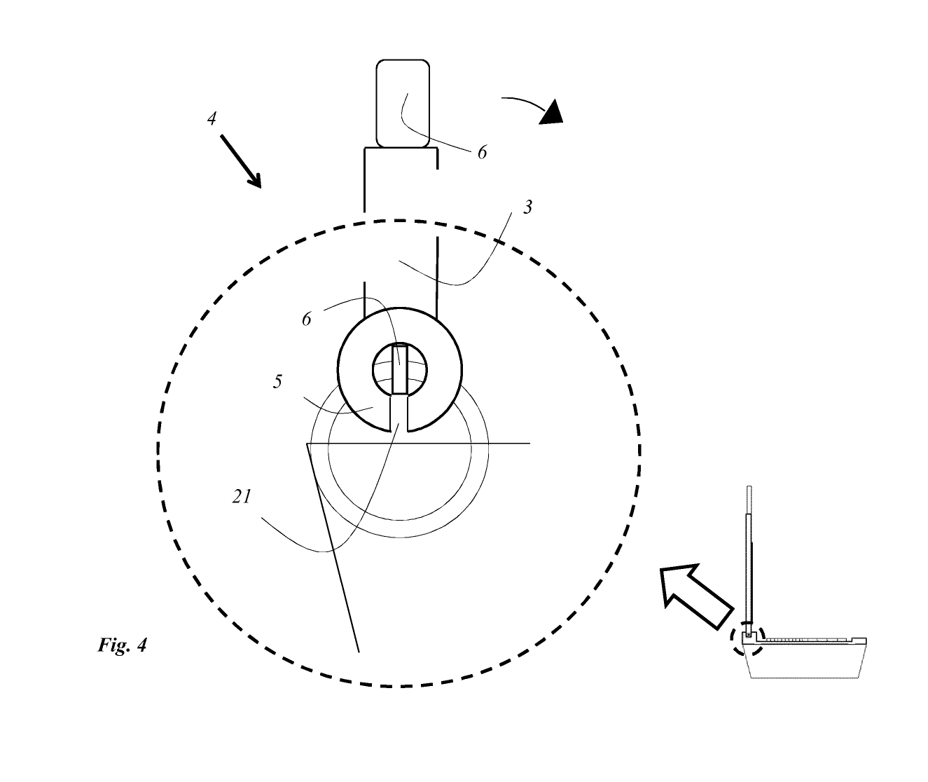

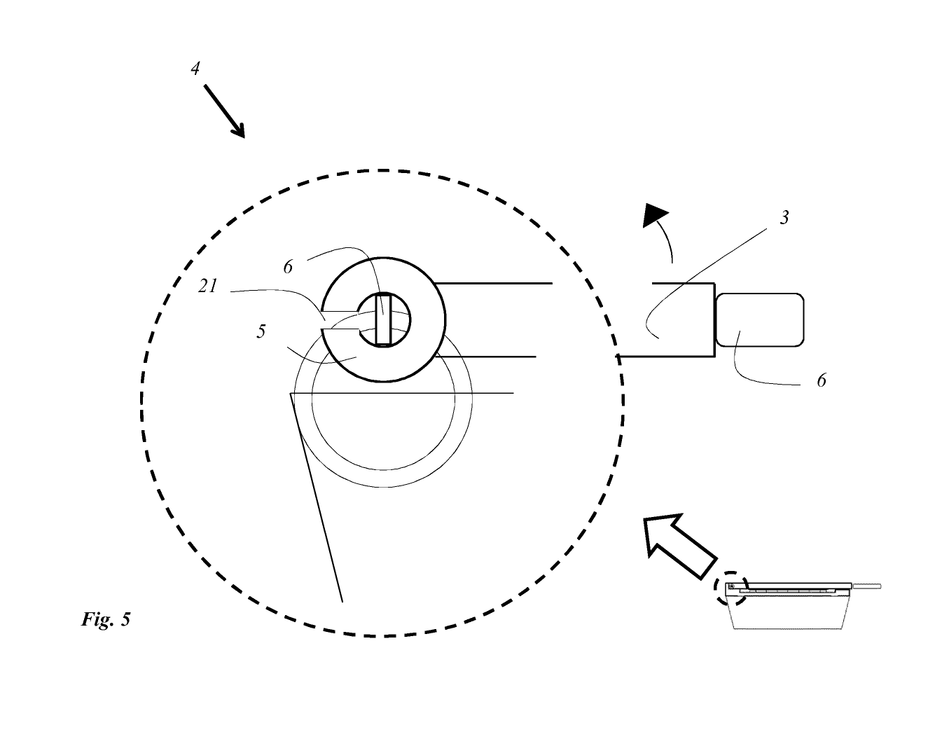

FIGS. 4 and 5 illustrate an exemplary embodiment of a joint 4 for the pivotable mounting of the actuation part 3 and of the drive device 12 on the base part 2. The joint is designed such that the actuation part 3 or the drive device 12 can, when required, be detached from one another, or pivotably fastened to one another, without tools.

FIG. 4 shows, in a side view, an enlarged illustration of the joint 4, in a position of the actuation part 3 in which the latter encloses an angle of 90° with the base part 2. The actuation part 3 (or the drive device 12) has a joint receptacle 5 which is of annular form in cross section and which has a passage 21. The base part 3 has the joint head 6. The passage 21 is dimensioned and designed such that the cuboidal joint head 6 can be detached from the joint receptacle 5 through said passage. In all other pivoting positions, detachment is not possible, as illustrated for example in FIG. 5. It is self-evidently conversely also possible for the actuation part 3 and the drive device 12 to have the joint head 6, while the base part 3 has the joint receptacle 5.

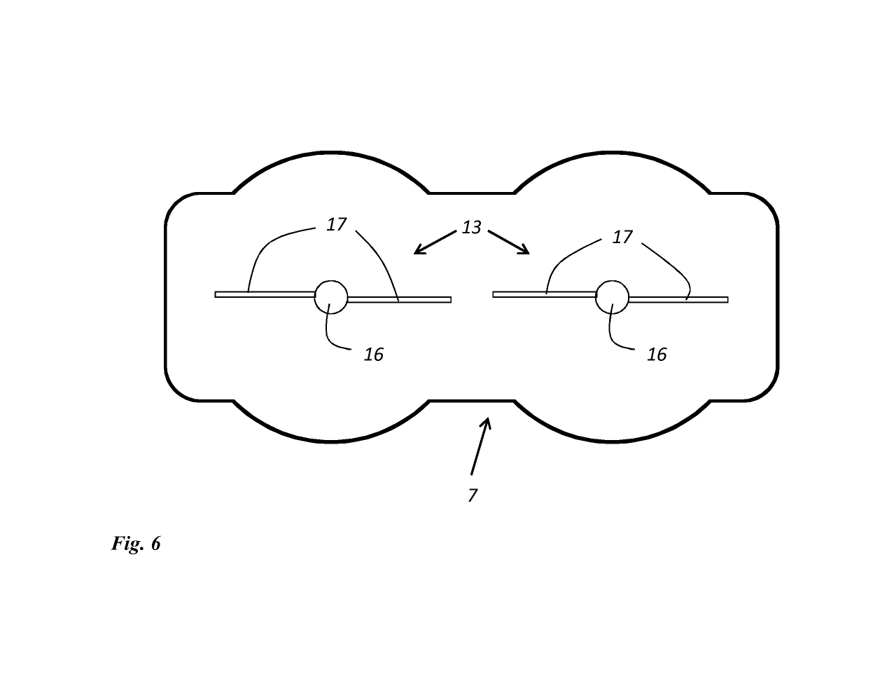

The container 7 preferably has two interconnected cylindrical chambers, into which in each case one rotary cutter 13 is insertable, as illustrated in the cross-sectional illustration of FIG. 6.

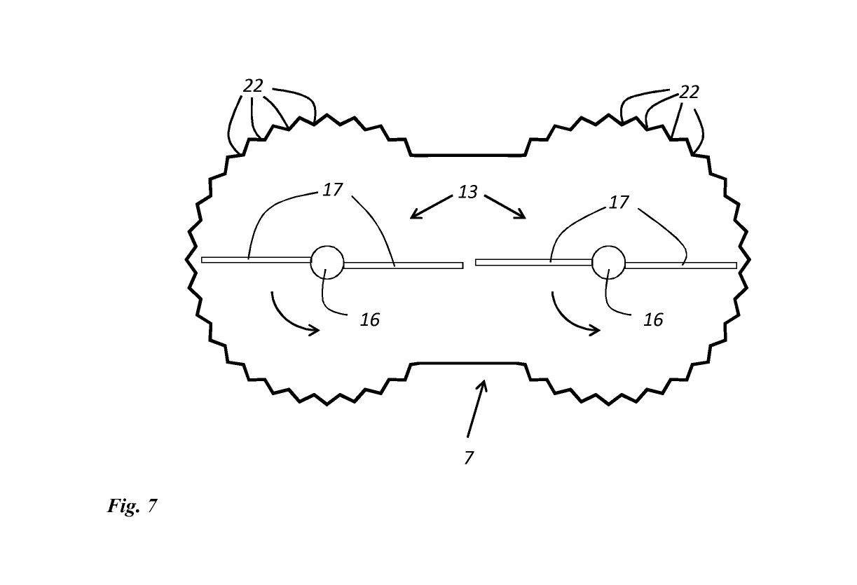

FIG. 7 is a cross-sectional illustration of another exemplary embodiment of a device according to the invention. In this exemplary embodiment, the container has two cylindrical, specifically circular cylindrical, chambers with ribs 22 oriented in an axial direction (with respect to the rotary cutters 13). The ribs 22 running parallel to the axis of rotation of the rotary cutters 13 have the advantage that the food items for comminution are additionally prevented from co-rotating with the rotating rotary cutters 13.

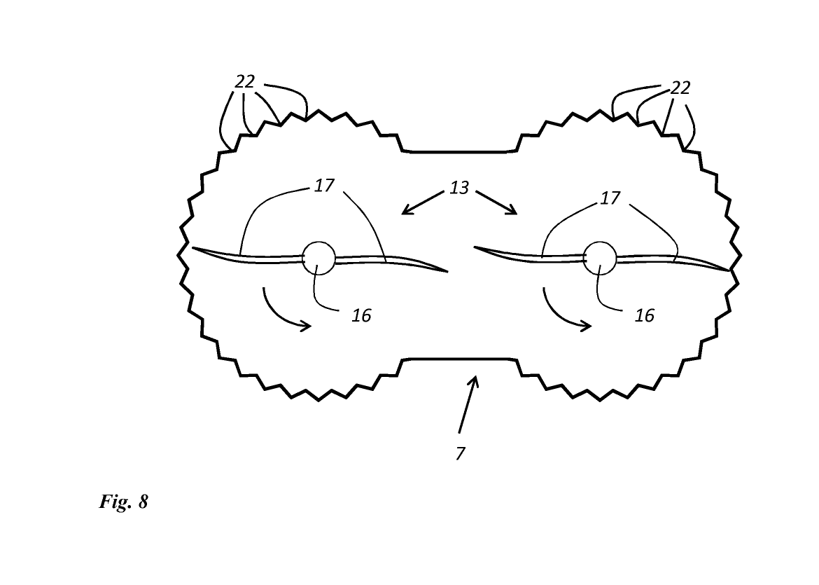

FIG. 8 is a cross-sectional illustration of a further exemplary embodiment of a device according to the invention, which is of identical construction to the embodiment illustrated in FIG. 7 aside from the design of the blades 17. In the further exemplary embodiment, the blades 17 are of curved form. In this further embodiment, it is the case in particular that the rotary blades 13 are driven in rotation simultaneously and in the same direction of rotation by means of the drive device.

### LIST OF REFERENCE NUMERALS

1 Device

2 Base part

3 Actuation part

4 Joint

5 Joint head

6 Joint shell

7 Container

8 Receptacle

9 Cutting part

10 Cutting part blades

11 Food items

12 Drive device

13 Rotary cutter

14 Hand crank

15 Driven shafts

16 Rotary shafts

17 Blades

18 Holding device

19 Bearing receptacles

20 Pins

21 Passage

22 Ribs

23 Handle

1. A device (1) for the comminution of foodstuffs, which device has a drive device (12) for driving at least one rotary cutter (13) in rotation and has a container (7), wherein the drive device (12) is fixable or fixed, in particular articulatedly, to a base part (2) and a holding device (18) is provided which, for the rotatable mounting of the at least one rotary cutter, is insertable or inserted into the base part (2) characterized in that the drive device (12), fixed articulatedly to the base part (2), can be selectively pivoted into an open position or a closed position.

2. The device (1) as claimed in claim 1, characterized in that the drive device is designed to drive two rotary cutters (13), and the device has two rotary cutters (13) for being rotatably inserted into the container (7), and in that the holding device (18) has two bearing receptacles for the rotatable mounting of the two rotary cutters (13).

3. The device (1) as claimed in claim 2, characterized in that the bearing receptacles are formed by two mutually parallel apertures in the holding device (18).

4. The device (1) as claimed in claim 1, characterized in that the holding device (18) has a passage (21) for the food items (11) for comminution and/or comminuted food items (11).

5. The device (1) as claimed in claim 1, characterized in that the holding device (18) is designed to be transparent.

6. The device (1) as claimed in claim 1, characterized in that
the drive device (12) is fixable or fixed articulatedly to the base part (2).

7. The device (1) as claimed in claim 1, characterized in that the base part (2) has a receptacle for a cutting part (9) and a cutting part (9) and in that an actuation part (3) is articulatedly fixable, in exchange for the drive device (12), to the base part (2) such that the actuation part (3) can be pivoted toward the cutting part (9), inserted in the receptacle, in order to push through food items (11) for comminution.

8. The device (1) as claimed in claim 1, characterized in that
a. the drive device (12) has a hand crank, and/or in that
b. the drive device (12) has a gearing, and/or in that
c. the drive device (12) has a speed-increasing gearing.

9. The device (1) as claimed in claim 2, characterized in that the rotary cutters (13) which are driven by the drive device rotate in the same direction.

10. The device (1) as claimed in claim 1, characterized in that the drive device (12) has at least one driven shaft to which a rotary cutter (13) can be rotationally conjointly coupled, and/or in that the drive device (12) has two driven shafts (15), to which in each case one rotary cutter (13) can be rotationally conjointly coupled.

11. The device (1) as claimed in claim 7, characterized in that
a. the base part (2), on the one hand, has at least one joint head (5) and the actuation part (3) and/or the drive device, on the other hand, has a corresponding joint receptacle for forming the articulated connection, or in that
b. the actuation part (3) and/or the drive device, on the one hand, has at least one joint head (5) and the base part (2), on the other hand, has a corresponding joint receptacle for forming the articulated connection.

12. The device (1) as claimed in claim 7, characterized in that
a. the articulated connection is designed such that the actuation part (3) or the drive device (12), at least in a predefined pivoting position, is detachable from the base part (2), in particular without tools and/or exclusively by virtue of the actuation part (3) and base part (2) being pulled apart, and/or in that
b. the articulated connection is designed such that the actuation part (3) or the drive device, exclusively in a predefined pivoting position or in a predefined pivoting position range, is detachable from the base part (2), in particular without tools and/or exclusively by virtue of the actuation part (3) and base part (2) being pulled apart.

13. The device (1) as claimed in claim 12, characterized in that
a. the predefined pivoting position lies at an angle in the range from 80° to 100°, in particular at an angle of 90°, between the plane of the base part and the plane of the actuation part, and/or in that
b. the predefined pivoting position range has an angle range of 70° to 110°, in particular of 80° to 100°, in particular of 85° to 95°, between the plane of the base part and the plane of the actuation part.

14. The device (1) as claimed in claim 11, characterized in that
a. the joint head receptacle has a radial opening through which the joint head can be removed from or inserted into the joint head receptacle in a radial direction, and/or in that
b. the joint head receptacle has an opening through which the joint head can be removed from or inserted into the joint head receptacle along a direction that differs from the direction of the pivot axis of the articulated connection.

15. The device (1) as claimed in claim 11, characterized in that the joint head (5) is of non-circular, in particular rectangular, form in cross section, and/or in that the articulated connection is in the form of a hinged joint.

16. The device (1) as claimed in claim 1, characterized in that the device (1) has at least one drive device, in particular a spring drive, for assisting or effecting the pivoting movement of the actuation part (3) and/or of the drive device (12) from a closed position into a loading position and/or from a loading position into a closed position.

17. The device (1) as claimed in claim 16, characterized in that the drive device is selectively activatable or deactivatable and/or in that the assistance force of the drive device is adjustable.

18. The device (1) as claimed in claim 1, characterized in that the base part (2) has a passage (19) for the comminuted food items (11).

19. The device (1) as claimed in claim 7, characterized in that multiple cutting parts can be inserted simultaneously into the receptacle and/or in that cutting parts of different size can be inserted into the receptacle.

20. The device (1) as claimed in claim 1, characterized in that the device is designed to be placed on a worktop for a comminution process, and/or in that the device has a stand for placing on a worktop.

21. The device (1) as claimed in claim 1, characterized in that a. the device has a container (7), and/or in that b. the device has a container (7) with two, in particular interconnected, cylindrical chambers, into which in each case one rotary cutter (13) can be inserted, and/or in that c. the device has a container (7) with two cylindrical chambers which merge into one another and into which in each case one rotary cutter (13) can be inserted.

22. The device (1) as claimed in claim 1, characterized in that the device is in the form of a cover which can be mounted onto a container (7)—preferably so as to completely cover the container opening—and/or can be fixed to a container (7).

23. The device (1) as claimed in claim 1, characterized in that the base part (2) can be mounted onto a container (7), and/or in that the base part (2) is formed as the container (7) for the comminuted food items (11).

24. The device (1) as claimed in claim 1, characterized in that the two rotary cutters (13) can be inserted rotatably into the container (7) such that said rotary cutters are rotatable about parallel axes of rotation.

25. The device (1) as claimed in claim 1, characterized in that the container (7) has at least one rotary bearing for the rotatable mounting of a rotary cutter (13), and/or in that the container (7) has two rotary bearings for the rotatable mounting of two, in particular mutually parallel, rotary cutters (13).

26. The device (1) as claimed in claim 25, characterized in that
a. the rotary bearing is in the form of a pin (20) which is arranged on the inner side of the container base and onto which a rotary cutter (13) can be or is mounted, and/or in that
b. the container (7) has, on the inner side of the container base, two mutually parallel pins (20) as rotary bearings for the rotatable mounting of two rotary cutters (13), wherein in each case one rotary cutter (13) can be or is mounted onto each pin.

27. The device (1) as claimed in claim 20, characterized in that the drive device, which is articulatedly fixed to the base part (2), can be selectively pivoted into an open position or a closed position.

28. The device (1) as claimed in claim 27, characterized in that the drive device (12), in the open position, is not coupled to the at least one rotary cutter (13) inserted into the container (7).

29. The device (1) as claimed in claim 27, characterized in that,
a. the drive device (12), in the closed position, is coupled to the at least one rotary cutter (13) inserted into the container (7), and/or in that
b. the drive device (12), during the movement from the open position into the closed position, is automatically placed in operative connection with the at least one rotary cutter (13) inserted into the container (7), and/or in that
c. the drive device (12), which is articulatedly fixed to the base part (2), and the at least one rotary cutter (13) inserted rotatably into the container (7) are positioned such that they are automatically placed in operative connection with one another during the movement of the drive device (12) from the open position into the closed position.

30. The device (1) as claimed in claim 1, characterized in that
a. the at least one rotary cutter (13) has a rotary shaft (16) on which at least one blade is arranged, in particular so as to run radially outward proceeding from the rotary shaft (16), and/or in that
b. the at least one rotary cutter (13) has a rotary shaft (16) on which two blades, which are offset by 180 degrees, are arranged in particular so as to run in each case radially outward proceeding from the rotary shaft (16), or in that the at least one rotary cutter (13) has a rotary shaft (16) on which three blades, which are offset by 120 degrees, are arranged in particular so as to run in each case radially outward proceeding from the rotary shaft (16), and/or in that
c. the at least one rotary cutter (13) has a rotary shaft (16) on which multiple blades are arranged at different axial heights of the rotary shaft (16).

31. A kitchen appliance having a device as claimed in claim 1, said device being in the form of a cover, and having a container (7) onto which the device is mounted—preferably so as to completely cover the container opening—and/or to which the device is fixed, preferably so as to be detachable again without tools.

32. The kitchen appliance as claimed in claim 31, characterized in that the kitchen appliance is designed to be placed on a worktop for a comminution process.
